(19) United States
(12) Patent Application Publication
(10) Pub. No.: US 2026/0226907 A1
(43) Pub. Date: Aug. 6, 2026

(54) CEILING FAN ASSEMBLY WITH HIDDEN BLADE SUPPORT

(71) Applicant: HKC-US, LLC, Memphis, TN (US)

(72) Inventors: Jeff Newman, Cornelius, NC (US); Brendan Byrns, Germantown, TN (US); DeVario Looney, Proctor, AR (US); James Burns, Memphis, TN (US)

(73) Assignee: HKC-US, LLC, Memphis, TN (US)

(21) Appl. No.: 19/532,027

(22) Filed: Feb. 6, 2026

Related U.S. Application Data
(60) Provisional application No. 63/754,827, filed on Feb. 6, 2025.

(51) Int. Cl. F04D 29/00; F04D 19/00; F04D 25/08; F21V 33/00

(52) U.S. Cl. CPC F04D 29/005; F04D 19/002; F04D 25/088; F21V 33/0096

(57) ABSTRACT

A ceiling fan assembly has a housing for housing a motor used to rotate a plurality of fan blades. A fixture mount having a light fixture or other type fixture mounted thereon is coupled to and positioned below the housing. A removable insert is inserted into a cavity of the fixture mount or otherwise coupled to the fixture mount. The insert is exposed such that the view of a person beneath the ceiling fan assembly is blocked by the insert thereby preventing the person from seeing components of the assembly that are positioned above the insert. Further, the exposed surface of the insert may be controlled (e.g., colored or mirrored) to provide an illusion that the fan blades are floating.

### CROSS REFERENCE TO RELATED APPLICATION

This application claims priority to U.S. Provisional Application No. 63/754,827, entitled “Ceiling Fan Assembly with Hidden Blade Support” and filed on Feb. 6, 2025, which is incorporated herein by reference.

### RELATED ART

A ceiling fan assembly typically has a housing that is coupled to a rotatable blade seat on which a plurality of fan blades is mounted. A motor situated in the housing may be configured to rotate the blade seat so that the fan blades mounted thereon also rotate and circulate air.

Given that ceiling fan assemblies are often mounted above areas where people are located, the mechanical integrity of a ceiling fan assembly is a highly important design consideration. In addition, a ceiling fan assembly by its nature is highly noticeable to observers in its vicinity, and it is desirable for its design and look to be aesthetically pleasing.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a perspective view of an embodiment of a ceiling fan assembly.

FIG. 2 is a bottom view of the ceiling fan assembly depicted by FIG. 1.

FIG. 3 is a block diagram illustrating components of a ceiling fan assembly, such as is depicted by FIG. 1.

FIG. 4 is a perspective view of the ceiling fan assembly depicted by FIG. 1 before an insert is installed into a cavity of a fixture mount of the ceiling fan assembly.

FIG. 5 is a perspective view of the ceiling fan assembly depicted by FIG. 4 after the insert is installed into the cavity of the fixture mount.

FIG. 6 is a perspective view of the ceiling fan assembly depicted by FIG. 5 after a light fixture is installed.

FIG. 7 is a bottom view of a ceiling fan assembly, such as is depicted by FIG. 1.

FIG. 8 is an exploded perspective view of a ceiling fan assembly, such as is depicted by FIG. 1.

FIG. 9 is an exploded side view of the ceiling fan assembly depicted by FIG. 8.

FIG. 10 is a perspective view of a ceiling fan assembly, such as is depicted by FIG. 1.

FIG. 11 is a perspective view of an insert for a ceiling fan assembly, such as is depicted by FIG. 1.

### DETAILED DESCRIPTION

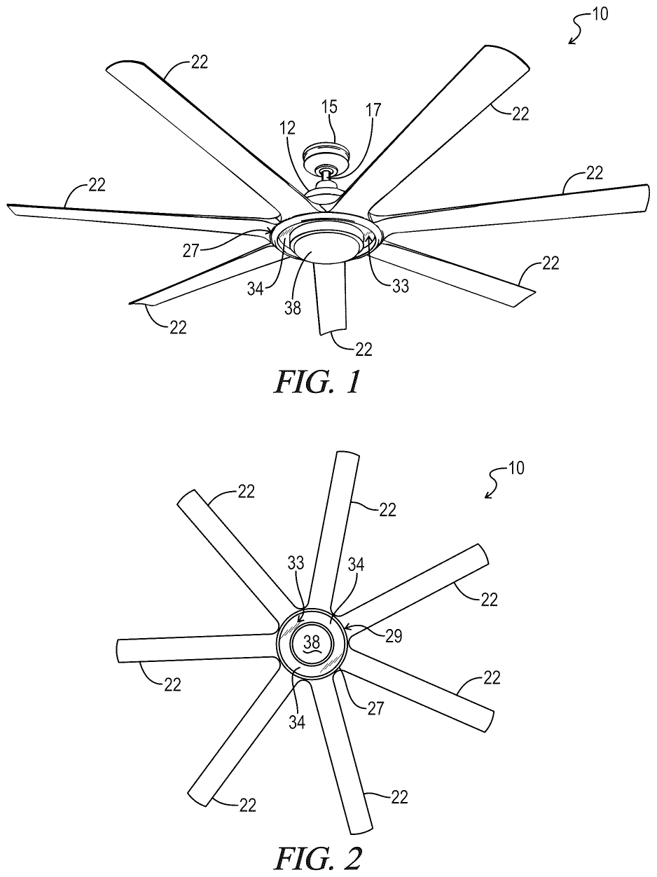

FIGS. 1 and 2 depict an embodiment of a ceiling fan assembly 10. As shown by FIG. 1, the fan assembly 10 comprises a housing 12 that is mounted on a ceiling. In this regard, a ceiling mount 15 is attached to a ceiling, and the housing 12 is coupled to the ceiling mount 15 by a support rod 17. In other embodiments, other techniques and designs for attaching the housing 12 to a ceiling or other structure are possible.

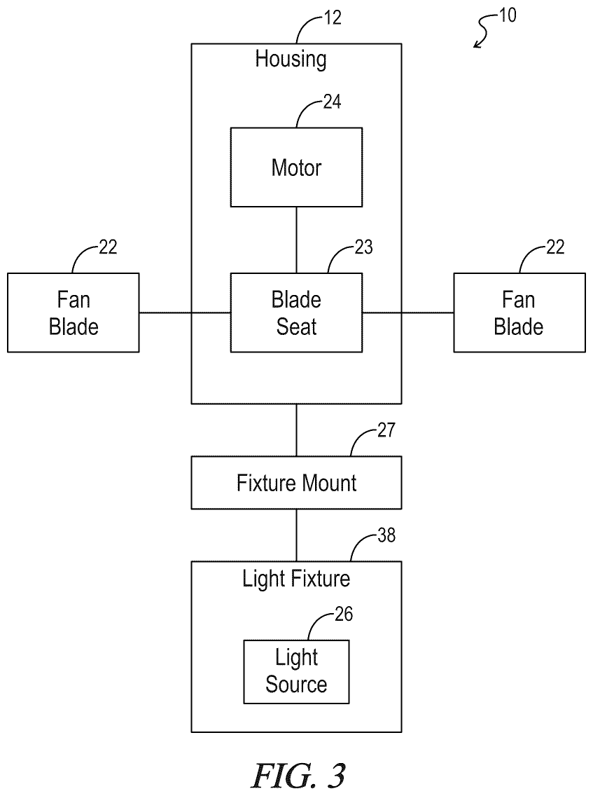

As shown by FIG. 3, each of a plurality of fan blades 22 is mounted on a blade seat 23 that is coupled to a motor 24 situated within the housing 12. The motor 24 is configured to rotate the blade seat 23, which in turn rotates the fan blades 22 causing them to circulate air. As shown by FIG. 10, each fan blade 22 may be coupled to the blade seat 23 by a plurality of screws 32 or other couplers that pass through the fan blade 22 and into the blade seat 23 (FIG. 3), which is hidden from view in FIG. 10. However, other techniques and designs for connecting the fan blades 22 to the blade seat 23 are possible.

As shown by FIG. 3, the blade seat 23 may be situated in the housing 12, which may be coupled to a light fixture 38 having a light source 26 (e.g., one or more light emitting diodes) for emitting light. In other embodiments, the blade seat 23 may be external to the housing 12 that houses the motor 24.

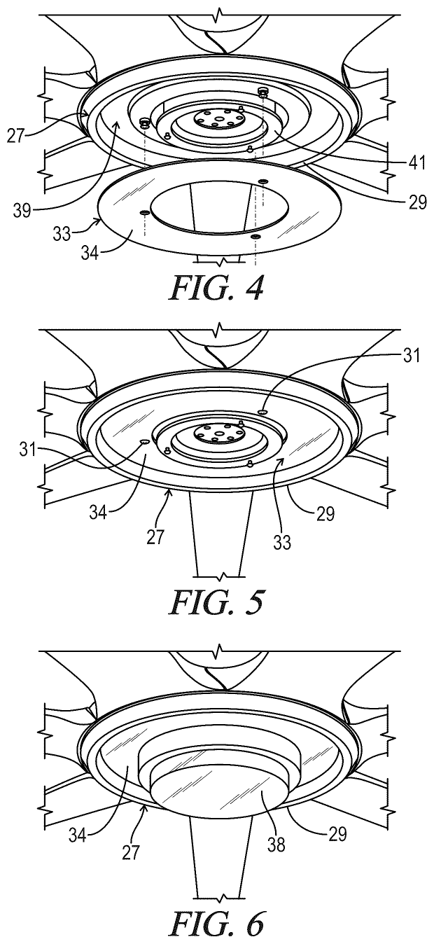

In the embodiment depicted by FIGS. 1-3, a fixture mount 27 is attached to the housing 12, and an outer edge of a bottom surface of the fixture mount 27 forms an outer ring 29 (FIG. 4). Further, a light fixture 38 is attached to the fixture mount 27 within the perimeter of the outer ring 29. A removable insert 33 is attached to a bottom surface of the fixture mount 27 so that the insert 33 is exposed to a user that is below the fan assembly 10. As shown, the removable insert 33 extends around an outer perimeter of the light fixture 38 and in some embodiments may extend entirely around such outer perimeter. However, completely encircling the outer perimeter of light fixture 38 in other embodiments is unnecessary.

Note that extending around the outer perimeter of the light fixture 38 does not require the light fixture 38 necessarily to pass through the insert 33 (e.g., the insert 33 and the light fixture 38 may be in different horizontal planes). By extending around the outer perimeter of the light fixture 38, the insert 33 is visible to a user who is below the assembly 10 since the outer perimeter (e.g., outer circumference) of the insert 33 is greater than the outer perimeter of the light fixture 38 irrespective whether the light fixture 38 and the insert 33 are in the same horizontal plane.

Note also that there are a variety of techniques that can be used to attach the insert 33. As an example, one or more screws 31 (FIG. 5) or other types of couplers may pass through the insert 33 into the bottom surface of the fixture mount 27 in order to secure the insert 33 to the fixture mount 27. In such an embodiment, the insert 33 may be removed by unscrewing or otherwise removing the screws 31 or other couplers, and the insert 33 may be pulled from the fixture mount 27 by hand and/or gravity. In other embodiments, other techniques may be used to attach the insert 33 to the fixture mount 27 or other components of the assembly 10, and it is possible for the insert 33 to be permanently attached to the fixture mount 27 (or other components of the assembly 10) or integrated with the fixture mount 27 (or other components of the assembly 10). As an example, the insert 33 may be dimensioned to snugly fit within a cavity (e.g., channel) defined by the outer ring 29 and an inner ring 41 of the fixture mount 27, as will be described in more detail below, such that frictional forces hold the insert 33 in the cavity unless and until the insert 33 is removed by hand.

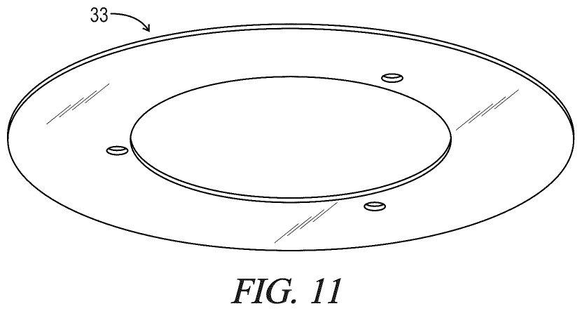

In the embodiment depicted by FIGS. 1 and 2, the insert 33 is a flat circular plate with a hollow center, thereby forming a ring, as shown by FIG. 4 and FIG. 11. However, the insert 33 may have other shapes and configurations in other embodiments. An outer surface 34 of the insert 33 is exposed and faces the floor when the fan assembly 10 is mounted on a ceiling. In some embodiments, the outer surface 34 is composed of a material that is reflective (e.g., a mirror), such as opaque plastic or metal, but other types of surfaces 34 are possible in other embodiments.

The insert 33 hides components of the fan assembly 10, such as portions of the blade seat 23, fixture mount 27, or other assembly components that are located directly above the insert 33. In this regard, the blade seat 23 or other components of the fan assembly 10 may include one or more structural components that may be unsightly or otherwise for which it is desirable to hide. As an example, if desired, the blade seat may include one or more steel rods or other structures composed of high strength materials that help to enhance the mechanical integrity of the fan assembly 10 and, in particular, support the fan blades 22, which can generate significant mechanical forces especially at high rotational speeds. Such components designed for providing substantial mechanical support may be unsightly such that the use of an insert 33 to hide them from view is desirable.

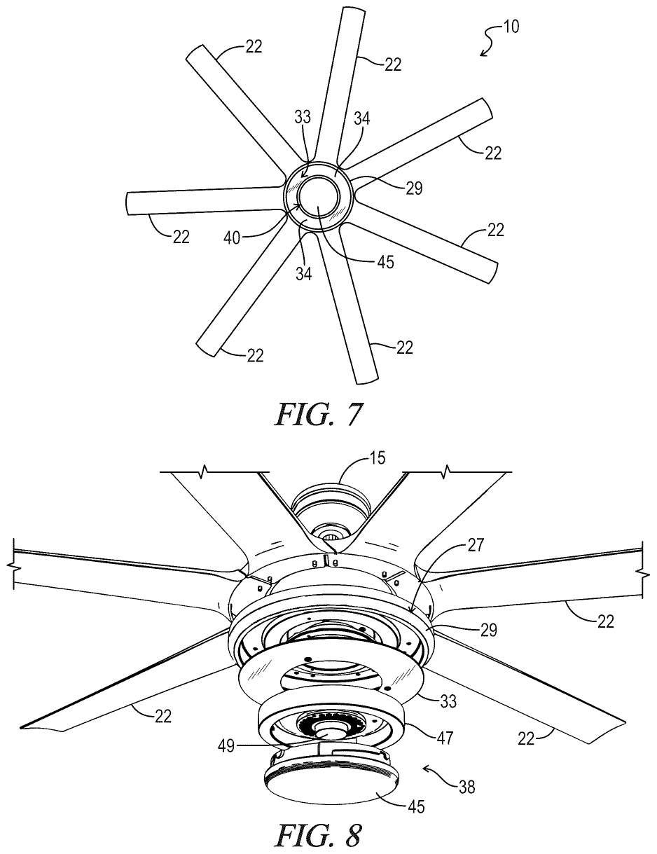

In addition, when the outer surface 34 of the insert 33 forms a mirror, the reflective aspect of the mirror may help to provide an illusion that the fan blades 22 are not connected to the housing 12. As an example, as shown by FIG. 2, when a user beneath the fan assembly 10 is looking up at the fan assembly 10, the user sees the fan blades 22, the outer ring 29 of the fixture mount 27, the outer surface 34 of the insert 33, and the light fixture 38, noting that the outer surface 34 is visible between the outer ring 29 and the light fixture 38. Because the outer surface 34 is mirrored, the space between the outer ring 29 and the light fixture 33 may appear to be a void (e.g., not a part of the fan assembly 10), as shown by FIGS. 2 and 7. That is, the fan blades 22 and outer ring 29 may appear as if they are floating without being mechanically attached to the housing 12 or light fixture 38.

Note that a similar effect of floating fan blades may achieved by making a portion of the blade seat with a translucent material as described by U.S. Pat. No. 12,117,011. In such a product, a user beneath the fan assembly may see through the fan assembly to view an object (e.g., ceiling) that is above the blade seat. However, using an insert 33 to hide components above the insert 33, as described herein, allows various components (e.g., high strength rods) for mechanical support or other purposes to be used above the insert 33 without being seen by a user beneath the fan assembly 10. Further, in embodiments with an insert 33, the use of a translucent material for the blade seat is unnecessary, and other types of material and components for supporting the fan blades 22 may be used.

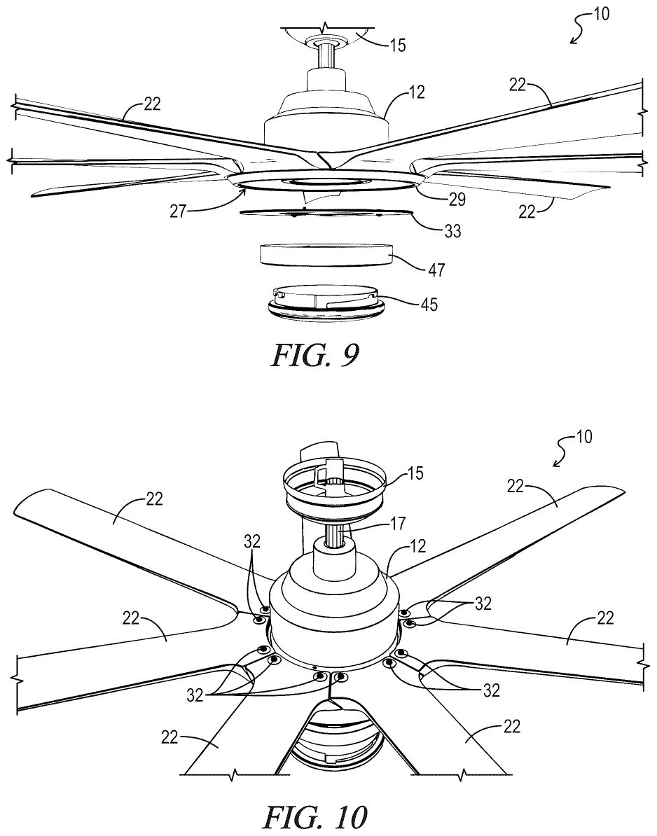

As shown by FIG. 4, the fixture mount 27 has a cavity 39 on its bottom surface for receiving the insert 33. This cavity 39 is defined by the outer ring 29, which is visible from below the fan assembly 10, and an inner ring 41 of the fixture mount 27. The light fixture 38 may be attached to the inner ring 41 when it is mounted on the fixture mount 27, as shown by FIG. 6. As shown by FIGS. 4-6, during installation, the insert 33 may be inserted into the cavity 39 defined by the inner ring 41 and the outer ring 29, and one or more screws 31 (FIG. 5) or other couplers (e.g., bolts or clips) may be used to attach the insert 33 to the fixture mount 27. Once the insert 33 is secured to the fixture mount 27, the light fixture 38 may be mounted to the inner ring 41 or otherwise secured to the fixture mount 27. FIGS. 8 and 9 show exploded views of the fan assembly 10. In the embodiment depicted by FIGS. 8 and 9, the light fixture 38 comprises a cover 45 that is attached to a light collar 47, which may be mounted on the inner ring 41 as described above. The light fixture 38 may have a light source 49 covered by the cover 45, and light emitted by such light source 49 may pass through the cover 45 to illuminate the room in which the assembly 10 is positioned.

In other embodiments, the use of a light fixture 38 is unnecessary. As an example, FIG. 7 shows an embodiment for which a solid fixture 40 (e.g., composed of plastic or other material) is mounted to the fixture mount 27 in place of a light fixture 38, noting that the depicted fixture 40 of FIG. 7 does not emit light. In this regard, the fixture 40 may have a cover 45, similar to the light fixture 38 of FIG. 6, except that the cover 45 of the fixture 40 of FIG. 7 is composed of an opaque material (e.g., plastic of a black or brown color).

In various embodiments described above, the outer surface 34 of the insert 33 is described as being mirrored, but other types of surfaces are possible in other embodiments. As an example, the outer surface 34 may be composed of a material that blocks light (e.g., is opaque), and the color of such surface 34 may be selected to substantially match a color of the ceiling. Thus, when a user views the fan assembly 10 from beneath, by having the same approximate color as the ceiling, the insert 33 may appear to be invisible such that the user has the illusion of seeing through the fan blade assembly 10 to the ceiling when, in fact, the user is seeing light reflecting from a colored surface of the insert 33. That is, it appears to the user as if he or she is seeing through the fan assembly 10 to the ceiling on which the fan assembly 10 is mounted. In such an embodiment, the fan assembly 10 may provide an illusion that the fan blades 22 are floating, as described above, while the insert 33 is blocking the user's view of components of the fan blade assembly 12 directly above the insert 33. In addition, by blocking a user's view with a component (e.g., insert) that is mirrored or colored to substantially match the ceiling, as described herein, provides the illusion at a relatively low cost with a relatively simple design.

Note that the configurations of the fan assembly 10 described herein allow for inserts 33 to be interchangeable as may be desired. For example, a user can purchase a fan assembly 10, select an insert 33 that matches his or her ceiling color, and install the selected insert. Afterword, such as after painting his or her ceiling a different color, the user may remove the insert 33 and replace it with an insert 33 of a different color that better matches the new ceiling color. That is, use of a removable insert 33 allows the color seen by a user below the fan assembly 10 to be controllable as may be desired. Use of the insert 33 with an outer surface 34 forming a mirror has the advantage of providing the effects herein regardless of ceiling color and/or without having to select or change a specific color of interest.

1. A ceiling fan assembly, comprising:
a housing;
a plurality of fan blades;
a motor situated in the housing for rotating the fan blades;
a light fixture having a light source;
a fixture mount coupled to the housing, the fixture mount having an inner ring and an outer ring defining a channel, wherein the light fixture is coupled to the inner ring; and
a removable insert positioned on the fixture mount in the channel and extending around an outer perimeter of the light fixture, wherein a surface of the removable insert is exposed.

2. The assembly of claim 1, wherein the surface of the removable insert is reflective forming a mirror around the outer perimeter of the light fixture.

3. The assembly of claim 1, wherein the removable insert forms a ring.

4. The assembly of claim 1, wherein the removable insert extends entirely around the outer perimeter of the light fixture.

5. A ceiling fan assembly, comprising:
a housing;
a plurality of fan blades;
a motor situated in the housing for moving the fan blades;
a fixture mount coupled to the housing;
a fixture mounted on the fixture mount; and
an insert positioned on the fixture mount and extending around an outer perimeter of the fixture, wherein a surface of the removable insert is exposed.

6. The assembly of claim 5, wherein the surface of the insert is reflective forming a mirror around the outer perimeter of the fixture.

7. The assembly of claim 5, wherein the fixture is a light fixture having a light source for emitting light.

8. The assembly of claim 5, wherein the insert forms a ring.

9. The assembly of claim 5, wherein the insert extends entirely around the outer perimeter of the fixture.

10. The assembly of claim 5, wherein the fixture mount has a channel extending around the fixture, and wherein the insert is positioned within the channel.

11. The assembly of claim 10, wherein the fixture mount has an outer ring and an inner ring defining the channel.

12. The assembly of claim 11, wherein the fixture is coupled to the inner ring.

13. The assembly of claim 5, wherein the insert is coupled to the fixture mount by at least one coupler that passes through the insert and the fixture mount.

14. The assembly of claim 13, wherein the at least one coupler comprises a screw.

15. The assembly of claim 5, wherein the insert is removable from the fixture mount.

16. A method for use with a ceiling fan assembly, comprising:
attaching a ceiling mount to a ceiling of a structure;
coupling a housing to the ceiling mount, the housing having a motor for rotating a plurality of fan blades of the ceiling fan assembly, the housing coupled to a fixture mount on which a light fixture is mounted; and
inserting a removable insert into a cavity of the fixture mount such that the removable insert extends around an outer perimeter of the fixture, wherein a surface of the removable insert is exposed.

17. The method of claim 16, wherein the surface of the removable insert is reflective forming a mirror around the outer perimeter of the light fixture.

18. The method of claim 16, wherein the removable insert forms a ring.

19. The method of claim 16, wherein the removable insert extends entirely around the outer perimeter of the light fixture.
